(19) United States
(12) Patent Application Publication
(10) Pub. No.: US 2018/0361780 A1
(43) Pub. Date: Dec. 20, 2018

(54) DEER ANTLER PEN AND BUSINESS CARD HOLDER COMBINATION SET

(71) Applicant: JASON F. RENYO, Millville, NJ (US)

(72) Inventor: JASON F. RENYO, Millville, NJ (US)

(21) Appl. No.: 15/962,082

(22) Filed: Apr. 25, 2018

Related U.S. Application Data
(63) Continuation of application No. 11/519,751, filed on Sep. 12, 2006, now abandoned.
(60) Provisional application No. 60/787,488, filed on Mar. 30, 2006.

(51) Int. Cl. B43K 23/00; B44C 5/06; B42F 5/00; B43K 29/00

(52) U.S. Cl. CPC B43K 23/001; B44C 5/06; B43K 29/00; B42P 2241/18; B42F 5/00

(57) ABSTRACT

An apparatus for holding at least one of a pen and a business card. The apparatus comprises a deer antler formed of natural deer antlers having various configurations depending on the shape of such deer antler when shed by a deer. At least one holder member is engageable with at least one prong of the deer antler for holding at least one of business cards and a pen. There is a means for securing the at least one holder member to such deer antler.

### CROSS REFERENCE TO RELATED APPLICATIONS

This application is closely related to and claims benefit from U.S. Provisional Application Ser. No. 60/787,488 filed Mar. 30, 2006.

### FIELD OF THE INVENTION

The present invention relates, in general, to a pen and/or business card holder, and, more particularly, the present invention relates to a pen and/or business card holder that is made using to deer antlers.

### BACKGROUND OF THE INVENTION

Deer antlers represent preserved natural beauty. When a hunter has acquired a rack from a deer such hunter may find a limited number of ways to display them. Traditionally the rack can be mounted on a wall. However, small racks would not ordinarily be used in a quality wall mount. This leaves the question of what to do with a rack that is too small to mount on a wall. Yet, such hunter would like to keep such antlers.

In addition to hunters, outdoor lovers often find shed antlers in the woods. These outdoor lovers are often seeking new ways to display their treasure.

Thus, it would be advantageous for these people if there were a convenient product which would allow the animal and outdoor enthusiasts a way of preserving these natural items that is both attractive and useful.

### SUMMARY OF THE INVENTION

In a first aspect the present invention provides an apparatus for holding at least one of a pen and a business card. The apparatus comprises a deer antler formed of natural deer antlers having various configurations depending on the shape of such deer antler when shed by a deer. At least one holder member is engageable with at least one prong of the deer antler for holding at least one of business cards and a pen. There is a means for securing the at least one holder member to such deer antler.

In a second aspect the present invention provides a process for treating deer antler sheds to restore the natural sheen and color to such deer antler sheds, the process comprises the steps of selecting a deer antler shed and then painting a base portion of the deer antler shed that was selected. There is a step of staining the deer antler shed selected previously with a preselected staining material and then a step of applying a protective translucent finish coat to the deer antler shed previously stained and a step of attaching at least one holder member to the deer antler shed for holding at least one of business cards and a pen.

In yet another aspect of the present invention there is provided an apparatus for holding at least one of a pen and a business card. The apparatus comprises a simulated deer antler formed of a preselected material and having a predetermined configuration. The predetermined configuration resembling a deer antler when shed by a deer. There is at least one holder member engageable with at least one prong of the simulated deer antler for holding at least one of business cards and a pen and a means for securing such at least one holder member to the simulated deer antler.

### OBJECTS OF THE INVENTION

It is, therefore, one of the primary objects of the present invention to provide a business card holder/pen holder that is made from deer antlers.

Another object of the present invention is to provide a business card holder/pen holder that uses deer antler sheds.

Still another object of the present invention is to provide a process for treating deer antler sheds to restore the natural sheen and color to such deer antler sheds

Yet another object of the present invention is to provide a business card holder/pen holder that is made from simulated deer antlers.

It is still another object of the present invention to provide a business card holder/pen holder that is both decorative and practical.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the apparatus according to an embodiment of the invention showing a deer antler shed being used as a card and pen holder.

FIG. 2 is a perspective view of the apparatus shown in FIG. 1.

FIG. 3 is a perspective view of another shape of antler being used for a pen holder with a feathered pen.

FIG. 4 is a perspective view of the apparatus according to another embodiment of the invention where such deer antler is a simulated version of a deer antler.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

The deer antler represents preserved, natural beauty. The present invention showcases deer antlers which have been processed and converted into unique pen holders, business card holders or combinations of both. These deer antler pen and/or business card holders are unique because they offer deer hunters or outdoor enthusiasts a new way to display business cards or pens. When a hunter has acquired a rack from a deer, he or she may find a limited amount of ways to display them. Traditionally, the rack is mounted onto a wall. Small racks would not ordinarily be used in a quality wall mount, leaving the question as to what to do with such antlers. In addition to hunters, outdoor lovers that find deer antler sheds in the woods often seek new ways to display their treasure.

It should be mentioned that within the concept of the invention when “deer antler” is described that such “deer antler” is meant to include such antlers from whitetail deer, blacktail deer, mule deer, elk and moose. All of these will be included when reference is made to either “deer antler” or “deer antler shed”.

The present invention provides an apparatus, generally designated 10, for displaying business cards 12 or pens 14 by utilizing such deer antler sheds 2. Such apparatus 10 comprises a deer antler shed member 2 formed of natural deer antlers 2 and having various configurations depending on the shape of the deer antler shed 2 that is found.

Such apparatus 10 further includes at least one holder member 22,24 that is engageable with at least one prong of such deer antler shed member 2. Such holder 22 is designed for holding one of business cards 12 or pens 14. There is also a means, generally designated 20, for securing such at least one holder member 22,24 to the deer antler shed member 2.

Such deer antler used for apparatus 10 can be one of left in the natural state, that is untouched, or the antler can be treated and polished. Such antler can be treated by painting and staining so as to preserve and protect the antler. It is presently preferred that such antler be painted and stained not only to preserve it better but to make it more attractive to the eye since untreated deer antlers when found are generally bleached out versions of white, black, gray and brown.

Such apparatus 10 includes a means 4 for protecting the base portion 6 which is that portion of the deer antler 2 which was attached to such deer's head. In the preferred embodiment of the invention the base portion 6 is painted with a gold paint to preserve the base portion 6 and to add to the beauty of the deer antler 2. In this embodiment such deer antler 2 is also treated with a stain which is used to impart a golden oak color to the antler. Such deer antler 2 is further coated with a translucent high gloss finish to preserve and enhance the appearance of the deer antler 2.

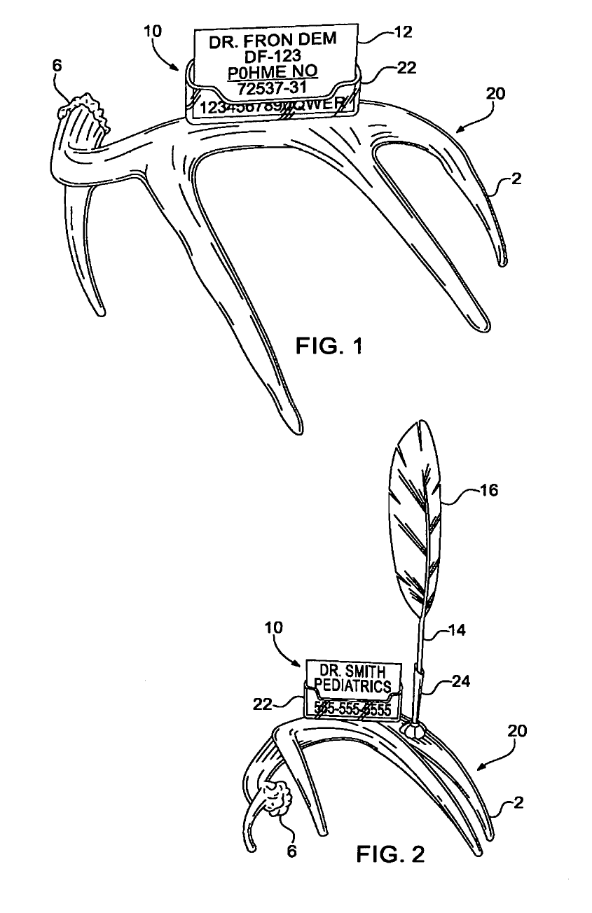

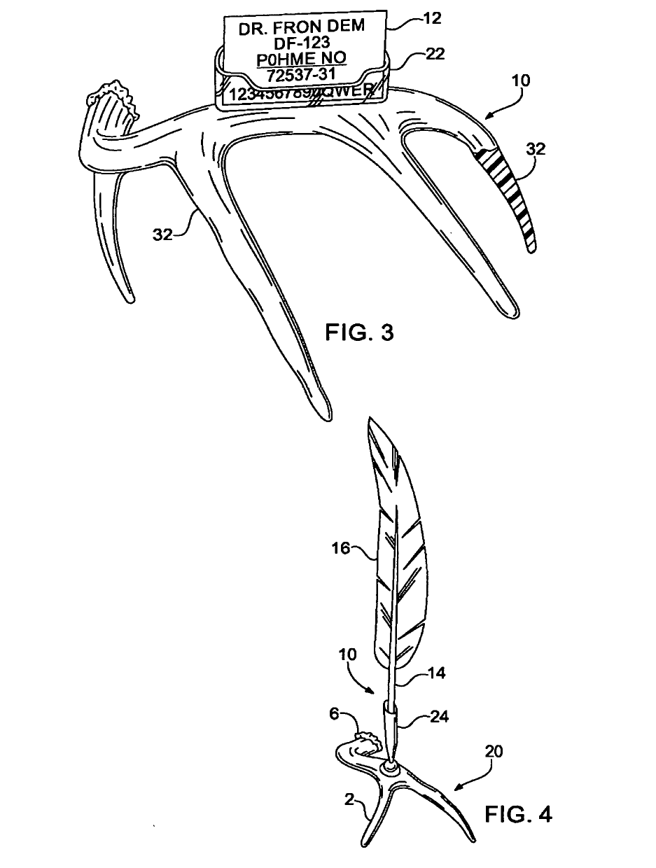

As stated previously such deer antler 2 has at least one holder member 22,24 disposed on the deer antler. As seen in FIG. 1 such holder 22 for holding business cards 12 is a substantially rectangular housing. Such holder 22 having such 2s substantially rectangular housing is made of one of plastic or metal. It is presently preferred that such holder is plastic. Further such holder can be clear or colored with a color compatible with paint or stain used to treat the antler.

As is evident in FIG. 2 the holder 24 designed for holding a pen 14 is an elongated substantially hollow tubular member. Such holder 24 is also made of one of plastic or metal. Again it is presently preferred that such holder 24 be made of plastic which can either be clear or colored in a color such as gold or silver to be compatible with the color of the deer antler 2.

It is presently preferred that such pen 14 disposed in the holder 24 of the deer antler 2 be further decorated by having one of a goose 16 and a turkey feather 16 attached to such pen 14. The use of feathers on the pen member 14 is in keeping with the attempt to have a completely natural appearance to the apparatus 10.

Such holder, be it 22 for business cards 12 or holder 24 for feathered pens 14, is secured to the antler by means of one of an adhesive or screws. The screws when used are screwed directly into the antler.

When antler sheds 2 are found, the majority of these sheds are bleached out versions having a white, black, gray or brown color. Thus, it is important to treat the deer antler sheds 2 so as to bring out the natural sheen and color of the antler sheds. In a second aspect the present invention provides a process for treating deer antler sheds 2 to restore the natural sheen and color to such deer antler sheds 2, the process comprises the steps of selecting a deer antler shed 2. There is a step of painting a base portion 6 of such deer antler shed 2 selected in a previous step. This followed by a step of staining such deer antler shed 2 selected previously with a preselected staining material. Applying a protective translucent finish coat to such deer antler shed 2 previously stained is another step in the process. There is step of attaching at least one holder member 22,24 to the deer antler shed 2 for holding at least one of business cards 12 and a pen 14.

Such process further includes the step of painting such base portion 6 with a gold paint to preserve and beautify the base portion and the step of using a stain with has a golden oak color. Such deer antler 2 now has a golden oak color.

There is also a step of using one of an adhesive or screws for attaching the at least one holder member 22,24 to the deer antler shed member.

The antlers can be from whitetail deer, blacktail deer, mule deer, elk and moose and such feathers could be from goose or turkeys or even other birds that have long distinctive feathers.

It is also within the scope of the invention that such deer antlers 2 are produced synthetically by using a hard resin or a polyethylene or polypropylene synthetic plastic material.

Thus, in another embodiment of the invention there is an apparatus 10 in which a simulated deer antler 32 is provided for holding such business cards or pens. Such simulated deer antler 32 is formed of a preselected material having a predetermined configuration. Such predetermined configuration resembles a natural deer antler 2 when shed by a deer. There is at least one holder member 22,24 engageable with at least one prong of the simulated deer antler 32 for holding at least one of business cards 12 and a pen 14. Such apparatus 10 includes a means, generally designated 20, for securing the at least one holder member 22,24 to the simulated deer antler 32.

It is presently preferred that such simulated deer antler 32 is formed from plastic and that such plastic is selected from one of a hard resin, such as a thermosetting polyester, polyethylene and polypropylene.

Although such apparatus 10 made from a simulated deer antler can look like the real deer antler and in some ways is more practical since it can be uniformly produced, it is generally preferred that such apparatus originate from a natural deer antler shed 2. This is in keeping with the natural aspect of the invention in preserving the natural beauty of such natural items as the deer antlers and the feathers used to decorate the pens.

Further, when using natural products each apparatus 10 will be slightly different from any other which makes each apparatus 10 unique.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. An apparatus for holding at least one of a pen and a business card, said apparatus comprising:
(a) a deer antler shed by a deer having various configurations depending on a shape of said deer antler;
(b) at least one holder member engageable with at least one prong of said deer antler for holding at least one of business cards and a pen; and
(c) a means for securing said at least one holder member to said deer antler.

2. The apparatus, according to claim 1, wherein said deer antler is one of as found in nature and as treated and polished.

3. The apparatus, according to claim 2, wherein said deer antler is treated and polished.

4. The apparatus, according to claim 3, wherein said deer antler is treated with one of paint and stain.

5. The apparatus, according to claim 4, wherein said deer antler is treated with a stain which imparts a golden oak color.

6. The apparatus, according to claim 5, wherein said deer antler is further coated with a translucent high gloss finish.

7. The apparatus, according to claim 2, wherein a base member of said deer antler is painted with a gold paint.

8. The apparatus, according to claim 1, wherein said at least one holder member is a substantially rectangular housing for holding business cards.

9. The apparatus, according to claim 6, wherein said substantially rectangular housing is made of one of plastic and metal.

10. The apparatus, according to claim 1, wherein said at least one holder member is an elongated substantially hollow tubular member for holding a pen member.

11. The apparatus, according to claim 8, wherein said pen is further decorated by having one of a goose and a turkey feather attached to an end of said pen.

12. The apparatus, according to claim 1, wherein said means for securing said at least one holder member to said deer antler is one of an adhesive and screws.

13. A process for treating deer antler sheds to restore the natural sheen and color to such deer antler sheds, the process comprises the steps of:
(a) selecting a deer antler shed;
(b) painting a base portion of said deer antler shed selected in step (a);
(c) staining said deer antler shed selected in step (a) with a preselected staining material;
(d) applying a protective translucent finish coat to said deer antler shed previously stained in step (c); and
(e) attaching at least one holder member to said deer antler shed for holding at least one of business cards and a pen.

14. The process, according to claim 13, wherein said preselected staining material used for staining said deer antler shed in step (c) is a stain with a golden oak color.

15. The process according to claim 13, wherein said step (e) for attaching said at least one holder member to said deer antler further includes one of an adhesive and screws.

16. An apparatus for holding at least one of a pen and a business card, said apparatus comprising:
(a) a simulated deer antler formed of a preselected material having a predetermined configuration, said configuration resembling a deer antler when shed by a deer;
(b) at least one holder member engageable with at least one prong of said simulated deer antler for holding at least one of business cards and a pen; and
(c) a means for securing said at least one holder member to said simulated deer antler.

17. The apparatus, according to claim 16, wherein said simulated deer antler is formed from plastic.

18. The apparatus, according to claim 17, wherein said plastic is one of a hard resin, polyethylene and polypropylene.

19. The apparatus, according to claim 18, wherein said hard resin is a thermosetting polyester.

20. The apparatus, according to claim 16, wherein said simulated deer antler is treated with a gold oak colored stain.
